(19) United States
(12) Patent Application Publication
(10) Pub. No.: US 2020/0172281 A1
(43) Pub. Date: Jun. 4, 2020

(54) LABEL WITH PRIZE AND METHOD FOR PRODUCING SAME

(71) Applicant: The Coca-Cola Company, Atlanta, GA (US)

(72) Inventors: Kenshi MATSUOKA, Tokyo (JP); Akiyoshi KANO, Tokyo (JP); Takashi KOBAYASHI, Tokyo (JP)

(21) Appl. No.: 16/615,196

(22) PCT Filed: May 24, 2018
(86) PCT No.: PCT/IB2018/053700

§ 371 Date: Nov. 20, 2019

(30) Foreign Application Priority Data
May 24, 2017 (JP) 2017-102686

(51) Int. Cl. B65C 3/08; G09F 3/10; G09F 3/02; B31D 1/02

(52) U.S. Cl. CPC B65C 3/08; G09F 3/10; G09F 3/02; G09F 2003/023; G09F 2003/0273; G09F 2003/0208; B31D 1/027

(57) ABSTRACT

The present invention provides a label with a prize offer having excellent concealment of a prize display and also provides a method enabling accurate and inexpensive production of the label. A label having a prize offer, wherein, using a center impression-type flexographic printing machine, a design layer, a prize offer display layer, and an underlayer are formed lying one over another by printing on a rear surface side of a translucent film, an opaque display base portion having high light-blocking properties is provided on the design layer, rear overprinting is performed on the prize offer display layer, while a transparent prize display is also provided to lie over the display base portion, or is not provided, back-rear printing is performed in the same color as the rear overprinting on the underlayer, and a transparent display window portion is provided to be aligned with the display base portion.

### TECHNICAL FIELD

The present invention relates to a label with a prize offer which is provided around a packaging element such as a beverage container, and to a method for producing same.

### BACKGROUND ART

PET bottles containing a beverage are generally sold in a form in which a film label is provided around an outer circumference of a body portion. When this kind of beverage is sold, a prize offer for which there is a fixed probability of winning is sometimes added to the label on the PET bottle for the purpose of a campaign or the like to increase buying motivation.

The technology disclosed in Patent Document 1 indicated below may be used as a method for adding a prize offer to a label by means of printing, in which method a design for the label and a prize display indicating “win” in relation to the prize offer are printed using cylindrical printing cylinders having different diameters, whereby the prize display can be seen at an interval corresponding to the lowest common multiple of circumferential lengths of the respective printing cylinders.

Furthermore, the technology disclosed in Patent Document 2 indicated below may be used as a method for concealing a prize display indicating “win” on a non-winning label, in which method a base layer provided with transparent display window portions at fixed intervals by performing solid printing, and a prize offer display layer in which a prize display of the same color as the solid printing is provided at different intervals to the display window portions, are formed one over another on a rear surface of a film, whereby the prize display can be seen only when it lies over the display window portions, and when the prize display is offset from the display window portions it conforms to the solid printing and cannot be seen.

### PATENT DOCUMENTS

Patent Document 1, JP 57-212090 A; Patent Document 2, JP 11-78327 A.

### SUMMARY OF THE INVENTION

However, in a gravure printing machine for soft packaging which is normally used in label printing, a number of printing units 53 including a printing cylinder 51 and an impression cylinder 52 are arranged in series, as shown in FIG. 6, and a film 50 passes through a space between adjacent printing units 53, so when printing cylinders 51 having different circumferential lengths are used in each printing unit 53, there is a risk that it will not be possible to print the prize display at a predetermined location.

Furthermore, when solid printing is performed on a film and a prize display is printed on top of this, the concealment afforded by the ink of the solid printing may be low, and a prize display indicating “win” may be visible through the ink.

When a digital inkjet printer which is able to freely control a printing image is used as a measure against this, there is a problem in that the cost involved in printing becomes higher.

In this regard, the problem addressed by the present invention lies in providing a label with a prize offer having excellent concealment of a prize display, and also in providing a method enabling accurate and inexpensive production of the label.

In order to solve the abovementioned problem, the present invention provides a label with a prize offer which has a film as a base material and is provided around a packaging element, wherein the film constituting the base material is translucent, a design layer is formed by means of printing on a rear surface side thereof, and a prize offer display layer and an underlayer are formed one over the other in any order, by means of printing, on a rear surface side of the design layer; a display base portion which is opaque and has high light-blocking properties is provided on the design layer; rear overprinting which is continuous in a direction constituting the circumferential direction of the packaging element is performed on the prize offer display layer, and a transparent prize display is provided in such a way as to lie over the display base portion of the design layer, or said prize display is not provided; and back-rear printing which is continuous in a direction constituting the circumferential direction of the packaging element is performed, on the underlayer, in the same color as the rear overprinting on the prize offer display layer, and a transparent display window portion is provided in such a way as to be aligned with the display base portion of the design layer.

Furthermore, the film is wrapped around the packaging element and both end portions thereof are overlapped and held bonded to the packaging element by means of adhesion at overlaps thereof; and the display base portion of the design layer is provided in such a way as to be positioned within the region of the outside overlap, out of the overlaps of the film.

Furthermore, according to a method for producing such a label, a center impression-type flexographic printing machine is used; the design layer is printed and formed on a rear surface of the film constituting the base material by means of a plurality of printing cylinders arranged around a central impression cylinder, and the prize offer display layer and the underlayer are printed and formed in such a way as to lie one over another in any order on a rear surface side of the design layer; during this printing, the unit length of the design layer and the underlayer is a reference length which is the length of a single label with a prize offer, and the unit length of the prize offer display layer is a non-reference length different than the reference length, whereby the prize display on the prize offer display layer lies over the display base portion of the design layer at intervals which are the lowest common multiple of the reference length and the non-reference length, and is apparent from the display window portion of the underlayer.

According to the label with a prize offer of the present invention, a front surface side of a film provided around a packaging element is covered by an opaque display base portion of a design layer having high light-blocking properties, ensuring excellent concealment.

Furthermore, on the rear surface side of the film, printing of the display base portion is transmitted by the prize display and the display window portion of the underlayer when the prize offer is a “win”, so it is possible to clearly see the prize display when a purchaser of the product looks at the rear surface side of the film.

On the other hand, there is no prize display if the prize offer is a “no win” and the display window portion conforms to the rear overprinting, so nothing can be seen from the display window portion.

Furthermore, this label can be accurately and inexpensively produced using printing cylinders having different circumferential lengths because printing is carried out using a center impression-type flexographic printing machine.

### BRIEF DESCRIPTION OF THE DRAWINGS

FIG. 1 is an oblique view showing a PET bottle around which is wrapped a label having a prize offer according to a mode of embodiment of the present invention;

FIG. 2 is an oblique view showing a state in which bonding at an overlap has been peeled to confirm a prize display, according to the same;

FIG. 3 (I) is an enlargement in cross section showing a bonded state and FIG. 3 (II) is an enlargement in cross section showing a state in which the bonding has been peeled to confirm the prize display, according to the same;

FIG. 4 shows the relationship of a design layer, a prize offer display layer and an underlayer on a rear surface side of a film during printing in the production of the label, according to the same;

FIG. 5 is a schematic diagram of a center impression-type flexographic printing machine used for printing, according to the same; and

FIG. 6 is a schematic diagram of an in-line gravure printing machine used for conventional label printing.

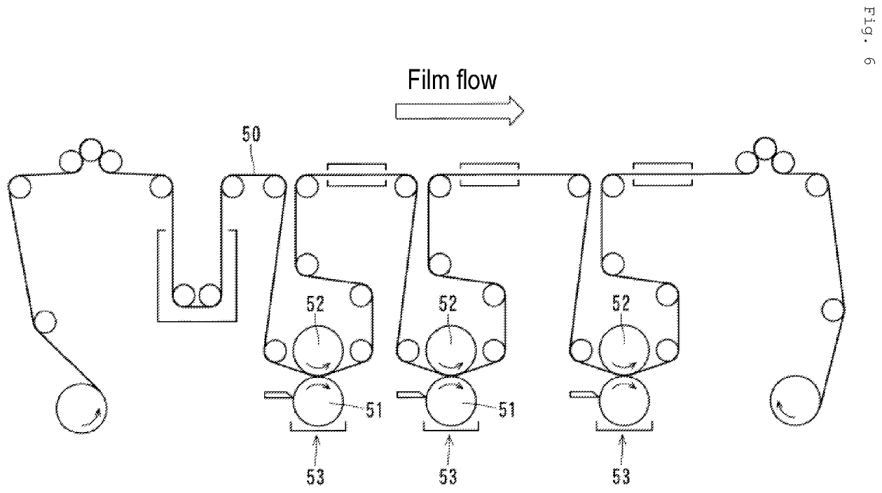

### MODE OF EMBODIMENT OF THE INVENTION

A mode of embodiment of the present invention will be described below with reference to the appended drawings.

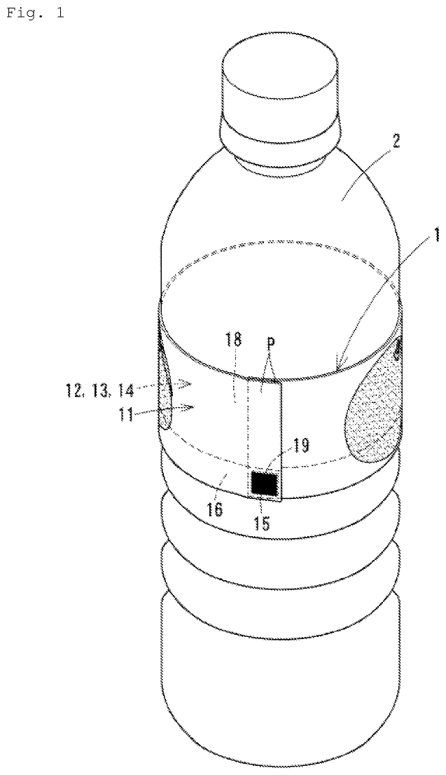

As shown in FIG. 1, a label 1 with a prize offer has a strip-shaped film 11 including polypropylene or the like as a base material, and is wrapped around the body portion of a PET bottle 2 constituting a packaging element, and both end portions thereof are overlapped and held in a bonded state with the body portion of the PET bottle 2 which contains a beverage, by means of bonding at overlaps P thereof.

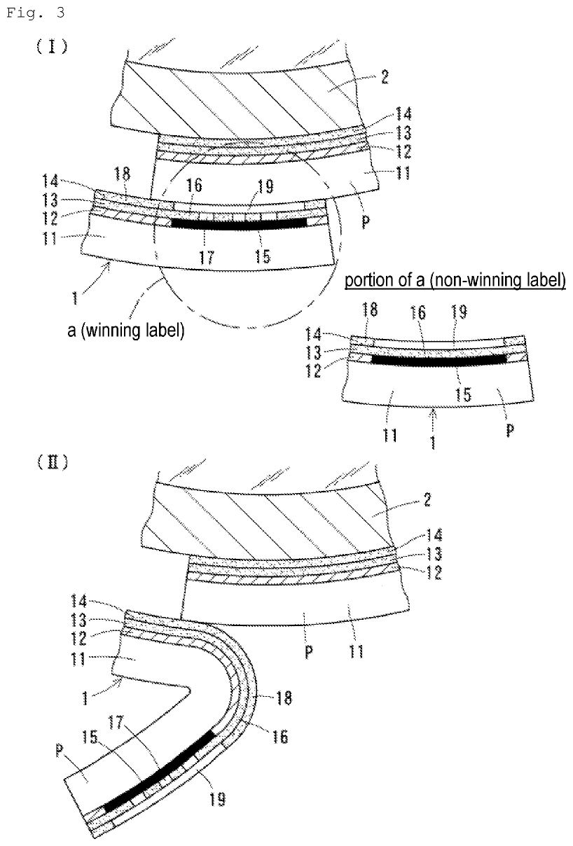

As shown in FIG. 3 (I), the film 11 constituting the base material is transparent, and a design layer 12, prize offer display layer 13 and underlayer 14 are laminated in succession and formed by means of printing on a rear surface side in a wrapped state around the PET bottle 2.

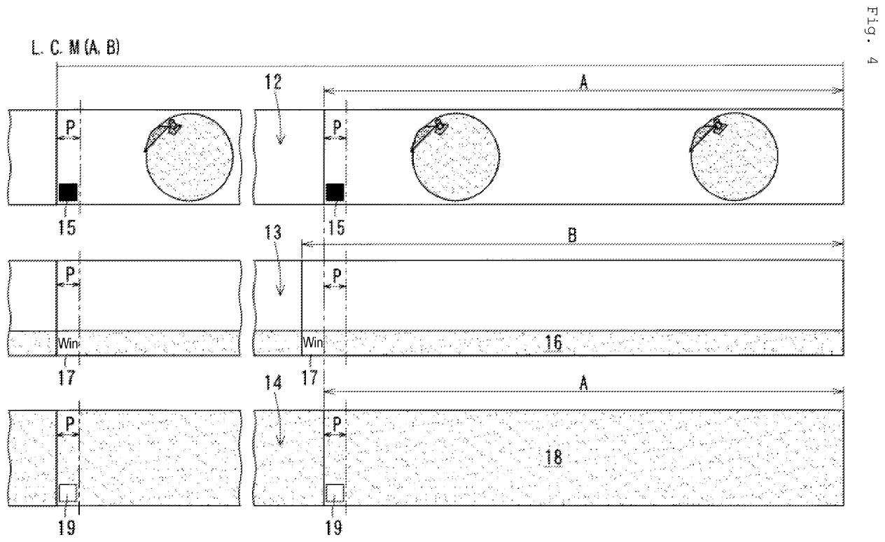

As shown in FIG. 3 (I) and FIG. 4, a logo of a product name or pattern for enhancing the image of a product, among other things, is printed on the design layer 12, and a square display base portion 15 which is opaque and has high light-blocking properties is provided by printing of a dark color on said design layer 12 in such a way as to be positioned within the region of an overlap P which is an overlapping portion on the outside, out of overlaps P of the film 11.

Solid printing of a white color which is continuous in a strip shape in a direction constituting the circumferential direction of the PET bottle 2 is performed as rear overprinting 16 on the prize offer display layer 13. When the prize offer is a “win”, a prize display 17 comprising the word “win” from which printing is absent so as to be transparent is provided in such a way as to be positioned within the display base portion 15 of the design layer 12, and when the prize offer is a “no win”, the prize display 17 is not located in that position and the rear overprinting 16 is white colored.

Solid printing which is continuous over the whole vertical width in a direction constituting the circumferential direction of the PET bottle 2 is provided as back-rear printing 18 on the underlayer 14 by means of a white color which is the same color as the rear overprinting 16 on the prize offer display layer 13, and a square display window portion 19 from which printing is absent so as to be transparent is provided in such a way as to be aligned with the display base portion 15 of the design layer 12.

As a result, when the prize offer is a “win”, the prize display 17 corresponds to the positions of the display base portion 15 and the display window portion 19, and the printing of the display base portion 15 is visible through the prize display 17 and the display window portion 19 from the rear surface side of the film 11 so the prize display 17 can be seen, and said prize display 17 is concealed by the display base portion 15 and cannot be seen from the front surface side of the film 11.

Furthermore, a prize display 17 which is offset from the positions of the display base portion 15 and the display window portion 19 is invisible not only from the front surface side but also from the rear surface side of the film 11 since it conforms to the back-rear printing 18, and when the prize offer is a “no win”, said prize display 17 is invisible not only from the front surface side but also from the rear surface side of the film 11, with the display window portion 19 conforming to the rear overprinting 16 and being concealed by the display base portion 15.

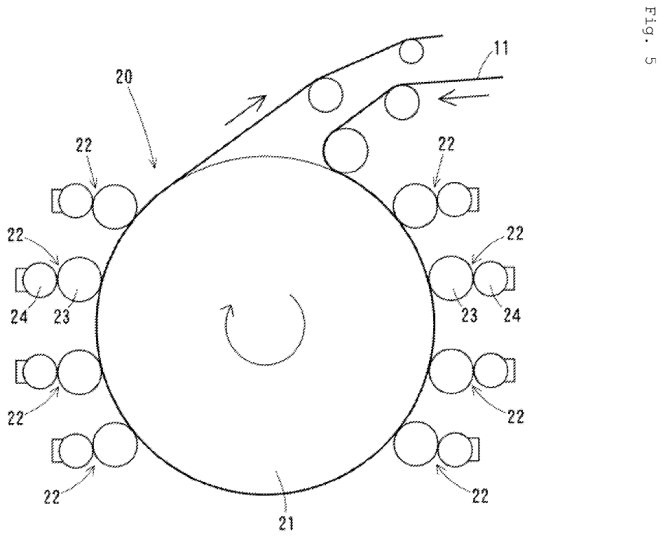

A center impression-type flexographic printing machine 20 such as that shown in FIG. 5 is used when the label 1 having a prize offer is produced. In this flexographic printing machine 20, a plurality of printing units 22 are arranged around a central impression cylinder 21, the printing units 22 each comprising a flexible resin printing cylinder 23 and an anilox roll 24 for supplying ink thereto.

Using the multiple printing units 22 of the flexographic printing machine 20, the design layer 12, prize offer display layer 13 and underlayer 14 are printed in succession and formed on the rear surface of the film 11 by means of the printing cylinders 23, as shown in FIG. 3 (I) and FIG. 4.

During this printing, the unit length of the design layer 12 and the underlayer 14 is a reference length A which is the length of a single label 1 with a prize offer, and the unit length of the prize offer display layer 13 is a non-reference length B greater than the reference length A, whereby the prize display 17 on the prize offer display layer 13 is apparent through the display window portion 19 of the underlayer 14 at intervals which are the lowest common multiple of the reference length A and the non-reference length B.

In order to perform this kind of printing using the flexographic printing machine 20 shown in FIG. 5, it is necessary to provide different circumferential lengths for the printing cylinders 23 of the printing units 22 that print the design layer 12 and the underlayer 14, and the printing cylinders 23 of the printing units 22 that print the prize offer display layer 13, but even if printing cylinders 23 having different circumferential lengths are used in the center impression-type flexographic printing machine 20, the film 11 is held on an outer circumferential surface of the impression cylinder 21, so there is substantially no misalignment when each layer is printed.

Furthermore, when conventional gravure printing or the like is used, the lower limit of the probability of winning is around 1/10, but when this kind of center impression-type flexographic printing machine 20 is used, the lower limit of the probability of winning can be set at considerably lower than 1/10.

As shown in FIG. 1 and FIG. 3 (I), with the abovementioned label 1 having a prize offer, the prize display 17 is provided on the outside overlap P, out of the overlaps P at both end portions of the film 11 wrapped around the PET bottle 2, and that portion is covered on the front surface side by the display base portion 15 which is opaque and has high light-blocking properties, while the inside overlap P of the film 11 lies over the rear surface side, therefore ensuring excellent concealment.

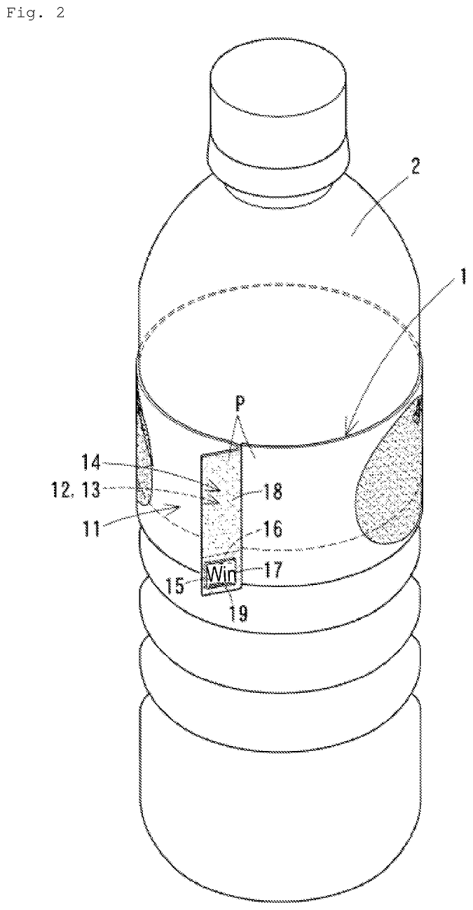

As shown in FIG. 2 and FIG. 3 (II), when a purchaser of the PET bottle 2 containing a beverage which is the product peels the bonding at the overlap P of the film 11 and turns over the outside overlap P, then if the prize offer is a “win”, the printing of the display base portion 15 is visible through the transparent prize display 17 and display window portion 19 so the prize display 17 can be clearly seen.

If the prize offer is a “no win”, on the other hand, there is no prize display 17 and the display window portion 19 conforms to the rear overprinting 16 so nothing can be seen from the display window portion 19.

Furthermore, the label 1 having a prize offer is printed using the center impression-type flexographic printing machine 20 so it is possible to use printing cylinders 23 having different circumferential lengths and said label can be produced more accurately and less expensively than in the case of printing using a gravure printing machine.

It should be noted that an example was described in the abovementioned mode of embodiment in which the film 11 is transparent, but the film 11 does not have to be colorless and transparent and may equally be colored and transparent or semitransparent, provided that the rear surface side is translucent and see-through.

Furthermore, an example was described in which the rear overprinting 16 and the back-rear printing 18 are white colored, but the rear overprinting 16 and the back-rear printing 18 need not be white colored, provided that they are the same color.

In addition, an example was described in which the rear overprinting 16 on the prize offer display layer 13 is in the shape of a strip narrower than the vertical width of the film 11, but the rear overprinting 16 may equally be applied over the whole vertical width of the film 11 in the same way as the back-rear printing 18.

Furthermore, an example of a roll label which is wrapped around a packaging element and has bonded overlaps at both ends was described as the label 1 with a prize offer, but the label 1 with a prize offer may equally be a shrink label which is caused to undergo thermal contraction in a state in which it covers the outer circumference of a packaging element in a cylindrical shape, or a stretch label which is bonded by expansion and contraction properties, or another type of label.

It should be noted that in the case of a shrink label or a stretch label, the overlaps P which conceal the prize display 17 from the rear side are absent, and if the beverage and the packaging element are both transparent, there is a risk of the prize display 17 being visible from the rear surface side of the film 11, so this label 1 with a prize offer may be applied when at least either one of the beverage and the packaging element is opaque.

In addition, the PET bottle 2 was described as the packaging element around which the label 1 with a prize offer is provided, but the label 1 with a prize offer may also be applied when the packaging element is a metal can or a paper pack, or the like.

### KEY TO SYMBOLS

1 . . . Label with a prize offer
2 . . . PET bottle
11 . . . Film
12 . . . Design layer
13 . . . Prize offer display layer
14 . . . Underlayer
15 . . . Display base portion
16 . . . Rear overprinting
17 . . . Prize display
18 . . . Back-rear printing
19 . . . Display window portion
20 . . . Flexographic printing machine
21 . . . Impression cylinder
22 . . . Printing unit
23 . . . Printing cylinder
24 . . . Anilox roll
A . . . Reference length
B . . . Non-reference length
P . . . Overlap

1. A label with a prize offer which has a film as a base material and is provided around a packaging element,
characterized in that the film comprising the base material is translucent, a design layer is formed by means of printing on a rear surface side thereof, and a prize offer display layer and an underlayer are formed one over the other in any order, by means of printing, on a rear surface side of the design layer;
a display base portion which is opaque and has high light-blocking properties is provided on the design layer;
rear overprinting which is continuous in a direction comprising the circumferential direction of the packaging element is performed on the prize offer display layer, and a transparent prize display is provided in such a way as to lie over the display base portion of the design layer, or said prize display is not provided; and
back-rear printing which is continuous in a direction comprising the circumferential direction of the packaging element is performed, on the underlayer, in the same color as the rear overprinting on the prize offer display layer, and a transparent display window portion is provided in such a way as to be aligned with the display base portion of the design layer.

2. The label with a prize offer as claimed in claim 1, characterized in that the film is wrapped around the packaging element and both end portions thereof are overlapped and held bonded to the packaging element by means of adhesion at overlaps thereof; and
the display base portion of the design layer is provided in such a way as to be positioned within the region of the outside overlap, out of the overlaps of the film.

3. A method for producing a label with a prize offer as claimed in claim 1, wherein a center impression-type flexographic printing machine is used;
the design layer is printed and formed on a rear surface of the film comprising the base material by means of a plurality of printing cylinders arranged around a central impression cylinder, and the prize offer display layer and the underlayer are printed and formed in such a way as to lie one over another in any order on a rear surface side of the design layer;
during this printing, the unit length of the design layer and the underlayer is a reference length which is the length of a single label with a prize offer, and the unit length of the prize offer display layer is a non-reference length different than the reference length, whereby
the prize display on the prize offer display layer lies over the display base portion of the design layer at intervals which are the lowest common multiple of the reference length and the non-reference length, and is apparent from the display window portion of the underlayer.
